(19) United States
(12) Patent Application Publication
(10) Pub. No.: US 2020/0372533 A1
(43) Pub. Date: Nov. 26, 2020

(54) SYSTEM AND METHOD FOR VALIDATING A TRANSACTION

(71) Applicant: Boloro Global Limited, New York, NY (US)

(72) Inventor: Karim Anwar Rammal, New York, NY (US)

(73) Assignee: Boloro Global Limited, New York, NY (US)

(21) Appl. No.: 16/993,402

(22) Filed: Aug. 14, 2020

Related U.S. Application Data
(63) Continuation of application No. PCT/US2019/017553, filed on Feb. 11, 2019.
(60) Provisional application No. 62/673,373, filed on May 18, 2018.
(60) Provisional application No. 62/631,547, filed on Feb. 16, 2018.

(51) Int. Cl. G06Q 30/02; G06F 16/23; H04L 9/32; G06Q 30/00; G06Q 20/20; G06Q 20/38; G06Q 20/04; G07F 17/32

(52) U.S. Cl. CPC G06Q 30/0212; G06F 16/2379; H04L 9/3247; G06Q 30/0185; G06Q 20/208; G07F 17/3223; G06Q 30/0236; G06Q 30/0238; G06Q 20/3825; G06Q 20/0457; G07F 17/329; G06Q 30/0208

(57) ABSTRACT

A system, method and computer program product for validating a transaction and recording the transaction to a trusted and/or immutable electronic ledger by implementing a first transaction between a user and an entity, upon concluding the first transaction, providing the user a possibility of entering into a complimentary second transaction via a graphical user interface, implementing the complimentary second transaction, and accessing a transaction system database to create profile of the user, permitting the user to complete the profile via the graphical user interface and set at least one authentication basis, validating the profile using the at least one authentication basis, and recording the first transaction and the complimentary second transaction in the trusted and/or immutable ledger in response to the validation.

### CROSS REFERENCE TO RELATED DOCUMENTS

The present disclosure is a continuation of PCT/US2019/17553 filed Feb. 11, 2019 and claims priority to U.S. Provisional Patent Application Ser. No. 62/631,547 of RAM MAL, filed on 16 Feb. 2018, and U.S. Provisional Patent Application Ser. No. 62/673,373 of RAMMAL, filed on 18 May 2018, the entire disclosures of all of which are hereby incorporated by reference herein.

### BACKGROUND

### Field

The present disclosure generally relates to methods and systems for validating a transaction, and more particularly to a method, system and computer program product for recording the transaction to a trusted and/or immutable electronic ledger such as a blockchain or other secure databases and the like.

### Discussion of the Background

The public in most countries across world can freely and safely participate in certain transactions between entities. However, such transactions may not be offered or may not be accessible to people in countries due to laws or restrictions, and the like. A need exists for an improvement in technology that will permit such activities in a way that is safe and secure but also complies with these laws.

### SUMMARY

Accordingly, there is a need for a method and system that addresses the above and other problems. To address the above and other problems, novel methods and systems are provided for a technical solution via a computer implemented system for validating a transaction and recording the transaction to a blockchain or other databases including circuitry that implements a first transaction between a user and an entity, upon concluding the first transaction, provides the user a possibility of entering into a complimentary second transaction via a graphical user interface, upon receiving a positive response from the user in response to the provision: implements the complimentary second transaction, and accesses a transaction system database to create a profile of the user, permits the user to complete the profile via the graphical user interface and set at least one authentication basis, validates the profile using the at least one authentication basis, and records the first transaction and the complimentary second transaction in the blockchain or other databases in response to the validation.

In addition, according to another exemplary aspect of the present disclosure there is provided a system, method and computer program product for lottery, betting or gaming, including a retailer system configured for selling goods and/or services to a purchaser in exchange for monetary or in-kind value exchange to conclude a transaction. The retailer system, upon concluding the sale to the purchaser, offers the purchaser an option of entering a free lottery, bet or game. The retailer system upon receiving a positive response from the purchaser configured to enter a lottery, bet or game and access a lottery, betting, game operator system database to create a profile of the purchaser. The purchaser completes the profile and sets authentication methods and validates against same via the system. The retailer system configured to scan or enter identifications of the goods and/or services that the purchaser paid for and record same in the profile of the purchaser. The retailer system configured to allow the purchaser to select a limited combination of elements from a broader universe of elements as a lottery entry, bet or game selection and store same in the profile in the database of the lottery, betting or game operator system. The retailer system configured to offer the purchaser one or more free lottery, bet or game entries per purchase or transaction by the purchaser, including scratch cards with pre-determined combinations that are discoverable instantly. The lottery, betting or game operator system configured to conduct a live draw or publish or reference other publishers of betting or game results at pre-determined and designated time and date securely and transparently and report the winning combination that the purchaser can manually or electronically match against the free lottery, bet or game entries. The lottery, betting or game operator system configured to use seller and buyer's profile, authentication and provenance of goods and/or services and/or lottery, bet or game entries to be traded.

Still other aspects, features, and advantages of the present embodiments are readily apparent from the following detailed description, by illustrating a number of exemplary embodiments and implementations, including the best mode contemplated for carrying out the present embodiments. The present disclosure is also capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIGS. 1A, 1B, 2 and 3 illustrate an exemplary system and process of a transaction;

FIGS. 4, 5 and 6 illustrate an exemplary flow chart corresponding to the exemplary process of FIGS. 1B-3;

FIGS. 7, 8, 9, 10 and 11 illustrate the operation of an exemplary system corresponding to the exemplary process and flow chart of FIGS. 1B-6;

FIGS. 12, 13 and 14 illustrate an exemplary process, as applied to betting or gaming, according to an exemplary embodiment;

FIGS. 15, 16 and 17 illustrate an exemplary flow chart corresponding to the exemplary process of FIGS. 12-14; and

FIGS. 18, 19, 20, 21 and 22 illustrate the operation of an exemplary system corresponding to the exemplary process and flow chart of FIGS. 12-17.

### DETAILED DESCRIPTION

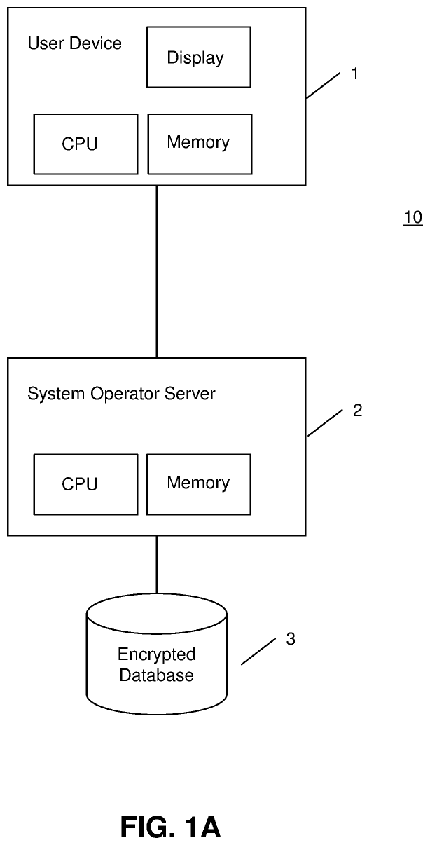

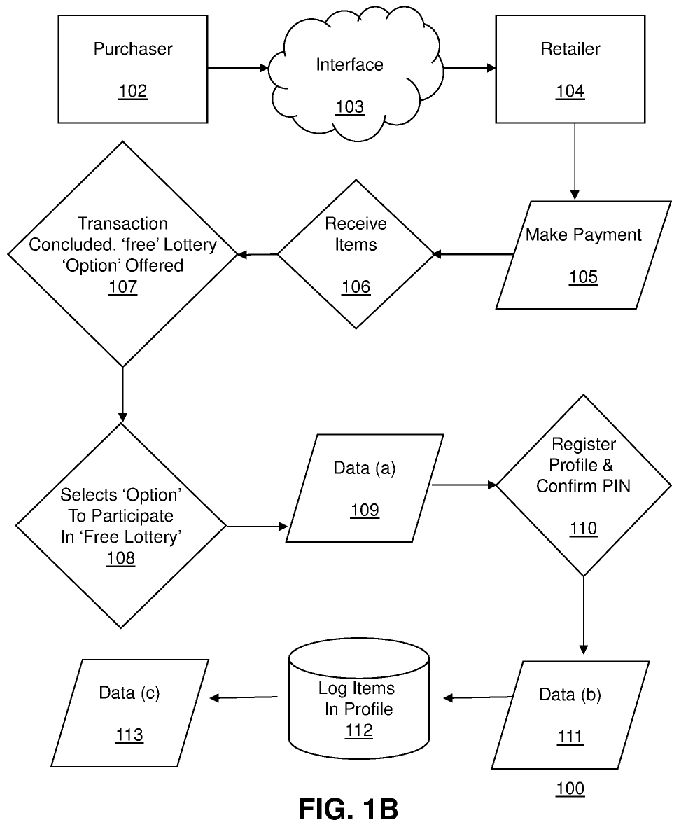

Advantageously, the system and methods, and related databases of FIGS. 1-22 can be based on blockchain technology, and can employ as needed non distributed ledger/database systems of the retailer and the operator of the lottery, betting or gaming platforms. The aspect of “trust” that the blockchain embodies advantageously lends itself as the underlying distributed ledger to ensure that (a) the transaction contract initiated and completed by the purchaser, (b) the choice made by the purchaser to positively select the “option” to enter a free lottery, bet or game, (c) the choice of the goods and/or service purchased as well as the wager or bet selection or entries selection combinations, are recorded with the profile of the registered purchaser and recorded in the purchaser's profile on the blockchain. The retailer and/or operator are able to calculate hashes to add entries to the blockchain or employ any other suitable technology, such as signed cryptographic messages, and the like. Such “trusted” entry can be referenced securely from time to time but is highly advantageous at the time of dispensing winnings to ensure that the purchaser had (a) purchased goods and/or services and that there was a value exchanged upon completion of the transaction, (b) that there was an “option” provided to the purchaser to “opt-out” of a free lottery, bet or game or to “opt-into” a free lottery, bet or game without any additional incentive or charge or, to forfeit the “option” without a “discount” or other such incentive. The “opt-into” and “opt-out” and any other suitable transactions can be recorded. Such aspect of the purchaser's selection from a “trusted” lookup, such as that recorded on the blockchain, negates any suitable dispute over whether purchaser entered for free into a free lottery. Furthermore, the entire record of the purchaser's registered profile, purchase of goods and/or service, provenance of the purchase, response to the option, as well as the wager or bet selection or entries selection combinations can be implemented as a smart contract that can also be triggered to execute winnings/payment in the form of blockchain tokens or other forms of electronic and/or cash payments (e.g., bank credits, credit card rewards, etc.), as needed, automatically, if their wager or bet selection or entries selection combinations match the draw/bet/game winning criteria.

Accordingly, as shown in FIG. 1A, a computer implemented system 10 is provided for facilitating and operating a free lottery, betting or gaming, including a retailer system or the system of the operator of the lottery, betting or gaming platforms for selling goods and/or services to a purchaser in exchange for monetary or in-kind value exchange to conclude a transaction, wherein the retailer system 2 or the system of the operator of the lottery, betting or gaming platforms 2, upon concluding the sale to the purchaser via a user device 1, e.g. kiosk, phone, apps, website, offers the purchaser an option of entering a free lottery, bet or game on their own encrypted system database 3 or a connected lottery, bet or game operator's encrypted system database which also uses blockchain to ensure data integrity, authentication, validation and storage of all records. The retailer or operator's encrypted system upon receiving a positive response from the purchaser enters a free lottery, bet or game and access a lottery, betting, game operator encrypted system database to create a profile of the purchaser on the blockchain or other databases. The purchaser completes the profile and sets authentication methods and validates via the encrypted system that is further validated against, and recorded on the blockchain or other databases. The retailer or operator's encrypted system scans or enters identifications of the goods and/or services that the purchaser paid for and records same in the profile of the purchaser on the retailer or the operator's encrypted system database and the blockchain. The retailer or operator's encrypted system allows the purchaser to select a limited combination of elements from a broader universe of elements as a lottery entry, bet or game selection and store same in the profile in the encrypted database of the lottery, betting or game operator system and replicated on the blockchain for further immutable security and record validation. The retailer or operator's encrypted database system is designed to offer the purchaser one or more free lottery, bet or game entries per purchase or transaction by the purchaser, including scratch cards with pre-determined combinations that are discoverable instantly and records for which can be validated on the retailer or operator's encrypted database system and on the blockchain to avoid any tampering or dispute. The retailer or the lottery, betting or game operator's encrypted database system conducts a live draw or publishes or references other publishers of betting or game results at pre-determined and designated times and dates securely and transparently and reports the winning combination that the purchaser can manually or electronically match against the free lottery, bet or game entries accessed from the retailer or operator's encrypted database system and validated and authenticated against the records maintained on the blockchain. The retailer or the lottery, betting or game operator's encrypted database system and blockchain records are designed to use seller's and/or buyer's profile, authentication and provenance of goods and/or services and/or lottery, bet or game entries to be traded allowing for true provenance validation and exchange and recorded on the retailer or the operator's encrypted system database and the blockchain.

Advantageously, the systems and methods can use a combination of security validation via retailer and operator's encrypted system databases as well as the immutable record-keeping capabilities of the blockchain which are able to authenticate and validate value transfer, provenance and the record of an offer to the customer to positively or negatively respond to an optional offer to enter a free lottery, bet or game thereby recording the fact that there was no incentive provided to influence the decision of the customer's response.

Advantageously, the systems and methods can record the positive or negative response of the customers to the offer for the option to enter the lottery, bet or game thereby proving that there is no incentive or value that influenced the decision and thereby any action taken by the customer to enter a lottery, bet or game is not considered gambling consistent with Sharia law, because there was no value wagered in entering the lottery and selecting their numbers or in placing a bet or playing a game and having a chance to win jackpots or other prizes.

The present disclosure further includes recognition of that lotteries, betting, games, and the like, are frowned upon or made illegal in certain countries because of the nature of the proposition, which is paying for a “chance” at winning a prize (e.g., at the expense of others who lose money) or some such reward. Therefore, such lotteries, betting or games are viewed as “gambling,” which is considered against the values of Islam and even a “sin” or “haram,” according to some scholars. For example, in the penal code of one of the countries in the Middle East it defines the process of gambling as “a game whereby each of the parties hereto agrees—in case he is the loser—to pay the winner a certain sum of money or any other thing agreed upon.” This renders gambling a punishable offence by a fine or in extreme cases imprisonment. For example, if a person is simply paying to play for “a chance” to win something without exchanging any tangible goods or services for the payment made, then the person has simply gambled with the money spent. That is considered Haram or “Sin” in the context of Islam. This consideration effectively deprives billions of people who adhere to these values from participating in and benefitting from the prospect, hope and actual winning of a grand prize, jackpot or other prizes that could positively impact their livelihood. According to a study in 2015, followers of Islam accounted for at least 24% of the world population and therefore there is a need to offer them an opportunity to participate in lotteries, betting, games, and the like, that can offer them hope for a chance to win and positively impact their livelihood.

Advantageously, the systems and methods of the present disclosure offer a lottery, betting, gaming, and the like, scheme that negates the “gambling” notion of a lottery and is in accordance to and respects the values of Islam and Sharia law, and the like, but additionally also offers a secure way of authenticating the transaction and purchase of goods and/or services and generates a record of provenance that then may itself increase in value in a secondary market. This authenticated exchange of value with a record of provenance then allows the purchaser an “option” to also play for free the lottery, place a free bet or enter a free game in the “hope” that they may win the grand prize, jackpot and/or other prizes that could positively benefit them and/or even change their livelihood. The record of the lottery, gaming or betting entries and numbers selection can also be stored securely in a database associated with the purchaser's profile or identity and access to which is controlled by the purchaser and authenticated against by the purchaser at the time of redemption against the master database/ledger maintained by the operator or sponsor of the lottery, betting, game and/or scheme and with the authentication system the purchaser can also sell their entry to a buyer because of the ability to authenticate and record provenance.

To further illustrate the novelty for the first part that addresses the notion of gambling, a person is offered to purchase a product such as a card (e.g., like baseball cards that are considered “collectors” items in the USA) and pays their face value price for it. The purchaser creates their profile in a database and selects their PIN/Password or other such secure authentication to protect their data and for future validation at the time of redeeming their prize and/or at the time they wish to trade the product and/or service with another authenticated registered user. The purchaser's information is then recorded (e.g., phone number, national ID, passport and/or any other state issued Identity Number, social media profile and any other suitable information that may be public or private that identifies the purchaser and can be used in the future to authenticate the person at the time of them transacting to exchange the card or product or service at a certain value with another authenticated purchaser). The purchaser, having bought such card or some such product is then offered the option to participate, enter, and the like, selection of numbers or team(s), side(s), participant(s), candidate(s), player(s), sports animal(s) for a chance to win the grand prize, jackpot or other prizes in a lottery, betting or gaming scenario, which could be any number of gaming options, betting types, sports betting, horse betting, lottery types, scratch card games, configurations, and the like, or that may be introduced in the future.

Once the purchaser buys the product or service and for this example the card, then effectively a transaction has concluded and value has been exchanged for the payment that was made. The seller then offers the purchaser an “option” to participate in a lottery, betting or gaming scheme for “free.” It is then the purchaser's choice whether they want to participate in the scheme for “free” and therefore the notion of gambling is clearly addressed because the purchaser of the goods or service and in this case the card, paid for what they received thus concluding the transaction and value exchange prior to accepting the “offer” to participate in the “free” lottery, betting or gaming scheme. The lottery, bet or game that the purchaser has an “option” to participate for “free” can also be viewed as a “promotion” to boost sales of the product or service that the purchaser intends to buy. Accordingly, the novel system and method immutably records the identity of the purchaser, as well as the purchase of the product and/or service, and provides the means for the purchaser to remotely or in-person authenticate themselves to exchange or reassign/transfer that product and/or service they had purchased to another registered person upon validated authentication. Therefore, it is envisaged that such a record of the purchase of the goods or services, as well as the selection of the optional “free” lottery, bet or game that the purchaser has participated in is then also recorded in a trusted and/or an immutable ledger (e.g., that could be based on Blockchain or some other suitable database, technique, and the like) that can be accessed to look up records when and as needed.

Accordingly, to illustrate the process of entering the optional “free” lottery, bet or game, for example, the purchaser (e.g., in the instantiation of one of several lottery and gaming methods) selects 6 out of 49 numbers or selects their team(s), side(s), participant(s), candidate(s), player(s), sports animal(s) on a draw sheet or on their mobile device (e.g., such as an electronic tablet or phone) or on an interactive television or via some other such method that allows for a combination of audio, visual, smell, touch or other sensory or some other choices to be made that would eventually need to match a draw, bet or game result that would take place upon a set time and date, or even scratch cards with pre-determined combinations that are discoverable, and the like. There can also be an option to allow the purchaser multiple entries in the “free” lottery, bet or game per purchase or transaction they have concluded and may also be given the option to use the same selection(s) for multiple draws as can be offered by the “free” lottery, bet or game or the scheme/game's operator if they choose to do so for any suitable reason. Such record of the purchaser's lottery, bet or game selection can then be recorded in their profile, and the like, in a database, and the like, to be then validated against at the time of redemption, as well as use their profile to have them authenticate themselves.

In addition, such “free” participation in the lottery, bet or game can also be offered to anyone purchasing any other suitable product or service from another seller, e.g., a third party, and the like, that can be different from the original seller of products and/or services that may be associated with the lottery, bet or game operator and/or the state. The products or services that the purchaser buys or consumes can also offer them an option to participate in the “free” lottery, bet or game and can range from any suitable physical product, such as a card, confectionery, food item, jewelry or some such physical thing of value, and the like, or can also be services or information that the purchaser wishes to avail or consume and to have the option to participate in the “free” lottery, bet or game. Such services or information consumed can range from someone's time being purchased, e.g., babysitting services, massage, delivery services, thoughts or ideas, viewing an advertisement, news, tutorials, providing time and/or services to someone or some such non-physical product exchange.

Another aspect of the novelty of this disclosure is authentication which provides the basis of validating the identity of the purchaser as the counterparty to the seller as well as in the event of a secondary sale of the product and/or service they hold, such as a card. Both the seller and the buyer need Authentication to securely conclude the transaction and eliminate fraud. Authentication is also advantageous upon the participant winning a prize for the lottery, bet or game they entered to make sure that the recipient of the prize is the original participant that had opted to participate in the “free” lottery, bet or game. Such feature is novel from current approaches to selling a lottery, bets or game ticket, whereby the participant in a lottery, bet or game may lose their ticket and someone else may claim the prize because there is no way to authenticate the original participant.

Authentication can also be used to assign a lottery, bet or gaming selection entry from the original purchaser of the card to another registered and authenticated person prior to the draw or after the draw. Authentication also allows the original participant the ability to sell or trade their lottery, bet or game entries with a buyer and thereby recording the transaction and provenance. Such a feature can even be applied to existing lotteries, bets or games. where disputes usually occur when multiple people have pooled to buy lottery, bet or game tickets or a when buyer and a seller trade a lottery, bet or game ticket.

Advantageously, the present disclosure includes recognition of and addresses problems associated with conventional systems of offering a lottery, bet or game to the Muslim population of the world that adhere to Islamic or Sharia law that states that lotteries, bets or games that are offered in their present state whereby a person pays for the chance to win a grand prize, jackpot/prizes or lose the money that he purchased the right to play/enter the lottery, bet or game is considered gambling. In essence, if a person is simply paying for “a chance” to win something without exchanging any suitable tangible goods or services for the payment made, then the person has simply gambled with the money spent. That is considered Haram or “Sin” in the context of Islam. This consideration effectively deprives billions of people who adhere to these values and are thus unable to “hope” to win a grand prize, jackpot or other prizes that could positively impact their livelihood.

Although such systems and methods may provide non-Muslim countries a straightforward way to offer lotteries, betting or gaming to their citizens they don't satisfy the Islamic or Sharia laws and beliefs many Muslim countries and their citizens adhere to and are thus deprived of the chance to enter a lottery, bet or game to hope for the chance of winning prizes that could positively impact their livelihood.

Advantageously, the exemplary method and system recognizes and addresses these and other limitations with such conventional lottery, bet or game schemes and systems offered and provides purchasers an “option” for a “free” lottery, bet or game entry with their purchase, enabling them hope and a chance to positively impact their livelihood if they win the jackpot or the other prizes. The present embodiments and exemplary method and system addresses these limitation by offering and conducting secure, authenticated Islamic and Sharia compliant lottery, betting or gaming by combining purchases of goods and/or services and offering the purchaser an “option to participate or enter a “free” lottery, bet or game and choose their selected numerical combination (or e.g., other combination of audio, visual, smell, touch or other sensory or some other choices that are made) or selects their team(s), side(s), participant(s), candidate(s), player(s), sports animal(s) in anticipation that may match the lottery draw at a particular time in the future, or scratch cards with pre-determined combinations that are discoverable or bet, game or event result. Thus, this exemplary embodiment, method and system address a quarter of the world's population who are otherwise deprived of entering a lottery, bet or game to hope for a chance to win and improve their livelihood.

The novel system and method, advantageously, provides a simple and secure lottery, betting or gaming system for the purchaser of the goods and/or services being promoted an “option” to enter the lottery, bet or game for “free” based on a novel process that enables a purchaser to remain in control of recording the purchase of the goods and/or services as well as the combination selection for the lottery, bet or game entry that is securely recorded in their profile database offered by the lottery, betting or gaming operator. The goods and/or services can be sold to the purchaser via the internet, via telephone sales persons or other interactive interfaces, via vending machines, other such retail environments and interfaces, and the like, or any other suitable way that a retailer or merchant may be selling goods and/or services, locally or globally, and the purchaser gets billed for the transaction by the merchant who then concludes the transactions and records the sale in the purchaser's profile database and offers them the option to also make a selection to enter the lottery for free and records that in the purchaser's profile database as well.

As compared with conventional systems, the novel system and process secures and records the purchase of the goods and/or service as well as the lottery, betting or gaming selection entry. Both items are in the purchaser's profile and control that they can then trade or transfer to another person with their profile on the operator's system or other another operator's system and record the provenance for future lookup or to address any queries or disputes. Other system user profiles can be with social media platforms, banks, wallets, governments and the like who are then connected to the lottery, betting or gaming operator's platform, which would then enable the transfer transaction in an authenticated way, thus to secure and record the provenance of the purchase and the lottery, bet or game entry.

The exemplary method and system involves a purchaser buying goods and/or services and paying for the goods and/or services through cash, credit or debit cards, mobile wallet, bank wallet or any other suitable form of tender type that the merchant may accept, for example, including foreign and cryptocurrency or some other such future tender type that may evolve. After the sale is completed and the retailer then offers the purchaser the option to enter a “free” lottery, betting or gaming scheme and to choose a combination of numbers or to select their team(s), side(s), participant(s), candidate(s), player(s), sports animal(s) (or e.g., other form of selection). The retailer then requests the purchaser's mobile number or other profile identifier to then record the purchase as well as the “free” lottery, bet or game entry selection for the upcoming next draw, bet, event or game so that it is recorded in the purchaser's profile. Once the record has been updated in the purchaser's profile, they are alerted via a notification call, text message, email or other such means of communication between the lottery, betting or gaming operator and the purchaser whose profile is maintained by the operator.

The lottery, betting or gaming operator then conducts a lottery draw, publishes and/or references other publishers for betting, gaming or some such event results on a set date and frequency with reputable auditors to endorse authenticity and broadcasts or streams it live for anyone to view ensuring transparency. The result of the draw, bet, game or event are then uploaded to the lottery, betting or gaming operator's site and the purchaser also receives notification of the draw combination selection. The lottery, betting or gaming operator can also go a step further to identify and notify the winner(s) of the grand prize, jackpot and other prizes or simply allow the purchaser to engage curiously to find out if they won.

A novelty of this present embodiments includes the recorded sale of the goods and/or services and the lottery, betting or gaming combination selection and entry in the purchaser's profile that also enables them to trade these with other profile holders that are registered on the lottery, betting and gaming operator's platform or even with third party platform profile holders who are connected to the lottery, betting or gaming operator's platform and have secure authenticated trades and exchanges enabled between the platforms.

To illustrate the trade, purchaser profile A holds a card with a unique number and a lottery, betting or gaming selection combination entry in their profile. They want to transfer both or one of these to a buyer profile B. The buyer or the purchaser can initiate the trade and the counterparty can authenticate it and approve the trade or transfer, and then the lottery, betting or gaming platform records the trade or transfer in a database or ledger, thus being able to prove provenance in the future for either the product and/or service that has been exchanged and/or the lottery entry that is now held by profile B.

Referring now to the drawings, wherein like reference numerals designate identical or corresponding parts throughout the several views and more particularly to FIGS. 1B-3 thereof there is illustrated an exemplary general process flow, according to an exemplary embodiment. In FIG. 1B, the process begins with purchaser at step 102 interfacing/interacting at step 103 with a retailer's store at step 104, such as an e-store (e.g., web site), telephone sales persons, interactive voice response (IVR) system, vendor, restaurant, other such interface, and the like, and including personal face-to-face, purchase or consumption of goods and/or services. The purchaser selects or purchases or consumes goods and/or services from retailer at step 104 and proceeds to make payment at step 105 for it at check-out where they have several payment options to choose from such as cash, card, cryptocurrency, foreign currency or any other suitable tender type. Once payment is made by the purchaser to the retailer, then the transaction is concluded and the purchaser receives the goods and/or service that they purchased at step 106. The retailer then offers the purchaser the “option” to enter the “free” lottery at step 107. The purchaser selects the “option” to enter the “free” lottery at step 108, and the merchant selects the option indicating the purchaser's desire to opt-in for the lottery, and the data at step 109 is recorded in the merchant's system, and asks the purchaser to create their digital profile registration at step 110. This can be implemented by a user interface having a pop-up notification on a computer screen of the kiosk or point of sale that displayed upon completion of the payment. For instance, the pop-up could state “Thank you for your purchase. You now have the OPTION to enter a FREE LOTTERY. Please click yes to OPT-IN or no to Exit.” The purchaser enters all suitable details that may be required by the lottery operator, for example, including name, license, passport, email, mobile phone number, picture, fingerprints, national identity number or card scan, age, sub-profiles of family members and their information, selection of authentication PIN, Password, Passcode, other such validation data point or points, and the like, at step 111, and the data is stored in the purchaser's unique profile on the lottery operator's platform, including the purchased goods or services at step 112 that is then stored and updated in the database at step 113.

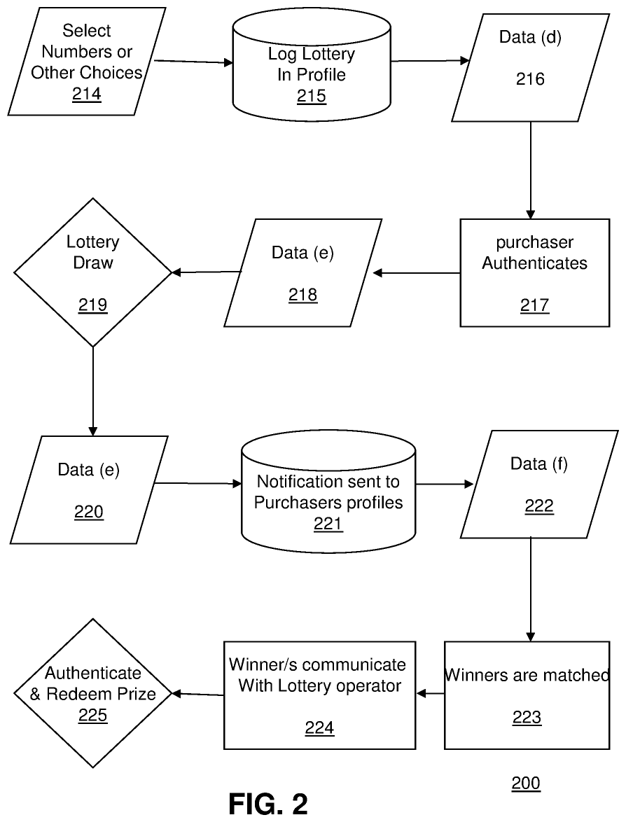

In FIG. 2, the purchaser selects the lottery combination and confirms their entry at step 214 into the lottery for the upcoming draw, which is then logged into their profile at step 215, and the database is updated at step 216. The purchaser is then asked to authenticate themselves with the authentication factor(s) that they had selected, thereby creating a digital signature certifying ownership of the goods and/or services, as well as the lottery selection combination entry at step 217, and the result of the verification, authentication is encapsulated, for example, as a digital signature that is then updated in the database at step 218. The lottery operator then conducts a live broadcasted lottery draw across multi-media with reputed auditors present to validate the authenticity of the draw and ensure trust and transparency at step 219. The lottery draw winning combination is then recorded in the lottery operator's database at step 220, and notifications are sent at step 221 to purchaser(s) via their profile using suitable channels, such as email, text messaging, social media, in-app notification, call to their telephone number, and the like, and which is logged in the lottery operator's database in step 222. If there are any matches from the entries with the draw results, winner(s) are matched at step 223, and the lottery operator can decide to notify the winner(s) via their contact information or can just let the winner(s) discover for themselves if they have won by referencing their entry against the draw numbers by either manual matching or clicking on a button in their profile that allows for automated matching to see if they won or matched any of the selections with the winning draw. The winner(s) at step 224 identify themselves and communicate with the lottery operator to redeem their prizes after authenticating themselves at step 225.

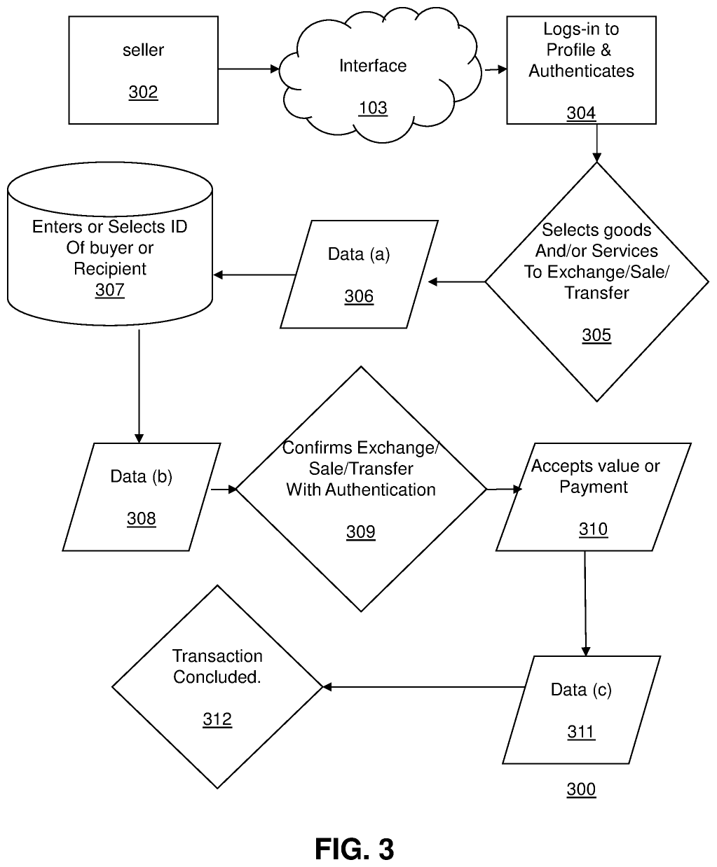

In FIG. 3, the trading process of the goods and/or services and/or the lottery selection combination entry is illustrated. The seller step 302 uses an interface at step 103 that can be implemented through a web browser, app or in-person at an authorized retailer, and the like, to login to their profile at step 304 after securely authenticating themselves. The seller then selects goods and/or services and/or lottery or game entry that they wish to trade or sell at step 305. The database records the selection at step 306 and generates a transaction token with all the suitable details referencing the selection of the items being transferred or sold and the buyer's information a step 307. The database then is updated with the transaction information at step 308. The seller and the buyer both authenticate the transaction and the entry is recorded in the database with their own authenticated digital signatures at step 309 after the agreed upon value or payment has been exchanged a step 310, and then the databases is updated at step 311, and which then provides receipts to both buyer and seller profiles, and the transaction is concluded at step 312

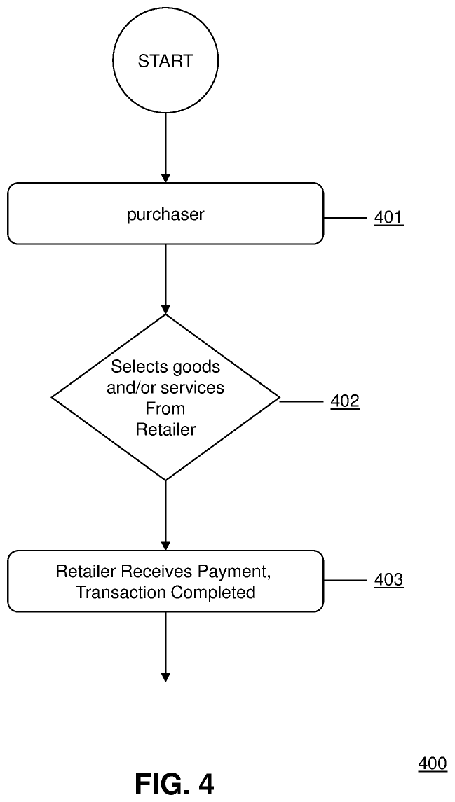

FIGS. 4-6 illustrate an exemplary flow chart corresponding to the exemplary process of FIGS. 1B-3. In FIG. 4, the purchaser 401 selects goods and/or services, for example, from a retailer, vendor, merchant and the like at step 402, for example, at a store, on the internet, vendor, vending machine, vending/gaming machine, restaurant, mobile browser, through a telephone sales person or sales IVR, and/or other such suitable sales avenues or interfaces, and the like, as the purchaser can be presented with by the retailer. The retailer at step 403 receives payment via any suitable payment option, such as cash, credit card, debit card, mobile wallet, mobile phone number or account, bank transfer, stored value cards, foreign currency, cryptocurrency, and the like. Upon receiving the payment, value is exchanged and the transaction is completed.

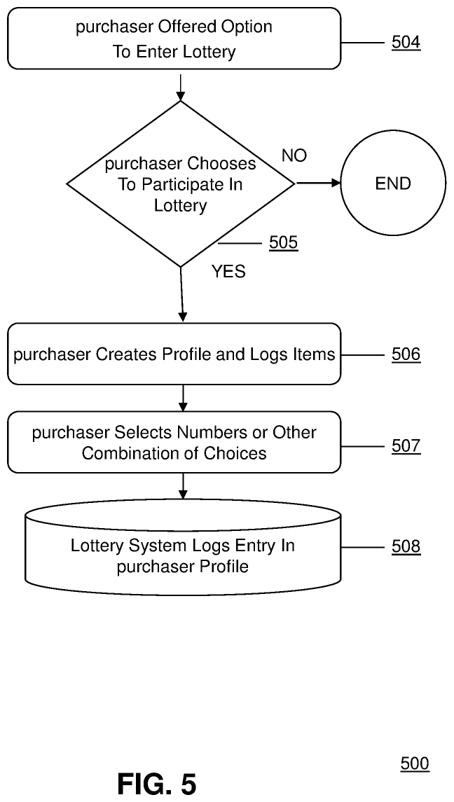

In FIG. 5, the retailer presents the purchaser an option to enter a “free” lottery at step 504, for example, by selecting their own lottery combination for their entry, for example, such as 4 numbers out of 49 numbers on a paper card or an interactive screen, such as that of a tablet, phone or suitable device, for example, including a cash register, and the like, of a merchant, and the like. The incentive for the purchaser is that the lottery entry is “free,” and that they hope to win the jackpot or some of the other prizes depending on whether their lottery selection combination matches the draw. If the purchaser doesn't opt to participate in the lottery, the transaction and process ends. If the purchaser opts to enter the lottery selection combination at step 505, they can create their user profile at step 506 with any suitable number of data points, for example, including name, license, passport, email, mobile phone number, picture, fingerprints, national identity number or card scan, age, sub-profiles of family members and their information, selection of authentication PIN, Password, Passcode, other such validation data point or points, and the like, and the data is stored in the purchaser's unique profile on the lottery operator's platform, for example, including the purchased goods or services that is then stored and updated in the database. The purchaser then selects their lottery combination at step 507, and an entry is created and stored in their profile at step 508.

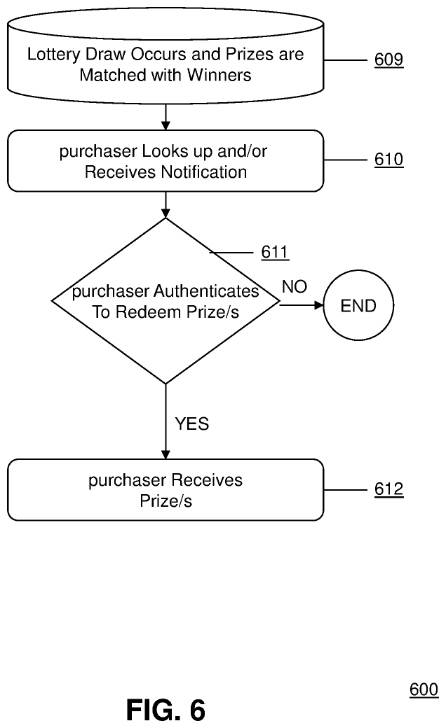

In FIG. 6, the lottery operator, for example, holds a live draw broadcasted and/or streamed to allow anyone, including the purchasers to view the draw and winning lottery combination live as it happens at step 609. The winning lottery combination is then published, and the purchasers are sent notifications at step 610, so that they can tally their lottery selection combination against the winning combination at step 611. The purchasers whose lottery selection combination do not match the winning in whole or partially don't win anything. The purchasers whose lottery combination match in whole or partially, as defined by the rules of the lottery, may then proceed to authenticate themselves to redeem their prize(s) at step 612. The prizes can be collected or delivered, in many forms, for example, including cash, check, money transfer, credit or debit card, cryptocurrency, foreign currency or some such other form of tender or physical goods or services, and the like.

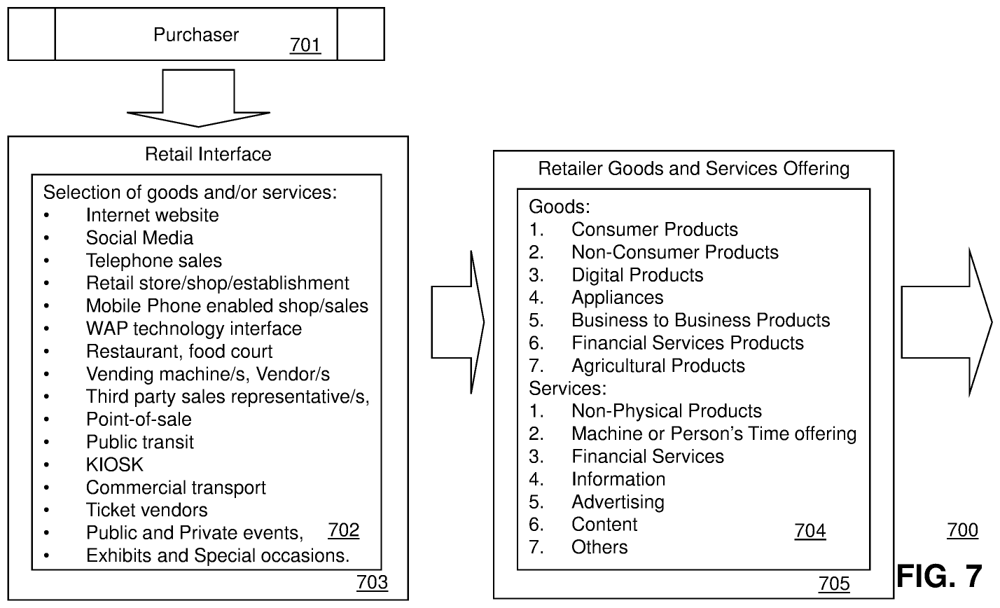

FIGS. 7-11 illustrate the operation of an exemplary system corresponding to the exemplary process and flow chart of FIGS. 1B-6. In FIG. 7, there is illustrated the authenticated sharia compliant lottery system 700, according to an exemplary embodiment. The system 700, begins with the purchaser 701 who interacts with a retailer's interface 703, whereby selecting goods and/or services 702 presented by the retailer to the purchaser to select and/or consume through a variety of ways including, for example, retailer's Internet website (e.g., e-commerce, e-retail, shop, sales front, etc.), telephone sales, retail, catalogue shop, team (e.g., call center, catalogue sales), mobile phone enabled shop, sales presence using, for example, Wireless Application Protocol (WAP) technologies, and the like, interfacing with, for example, the internet, physical store front or other such establishment in the form of retail store, shop, including, for example, restaurants, vending machines, vendors, third party representatives, point-of-sale including, for example, services such as payment mechanisms configured for public transport such as taxis, buses, subways, metro, underground and over ground transport, trains, monorails, commercial aircraft, airlines, buses and other transport, toll-booths, ticket vendors, stands, Internet sites for public and private events, exhibits and special occasions, interactive televisions or other such screens in homes or other private or public places, smartphones or feature phones, through apps on the smartphone or computers, and the like.

The retailer offers goods and/or services selected by the purchaser at 705 that can include physical goods, such as merchandize of a certain value, limited edition collector's cards, antiques, financial services products, agricultural products, appliances, digital goods, non-consumer products, such as industrial equipment, and the like. The retailer can also offer services, such as machine time, person's time, information, advertising, advice, content and other non-tangible services, and the like presented in 704.

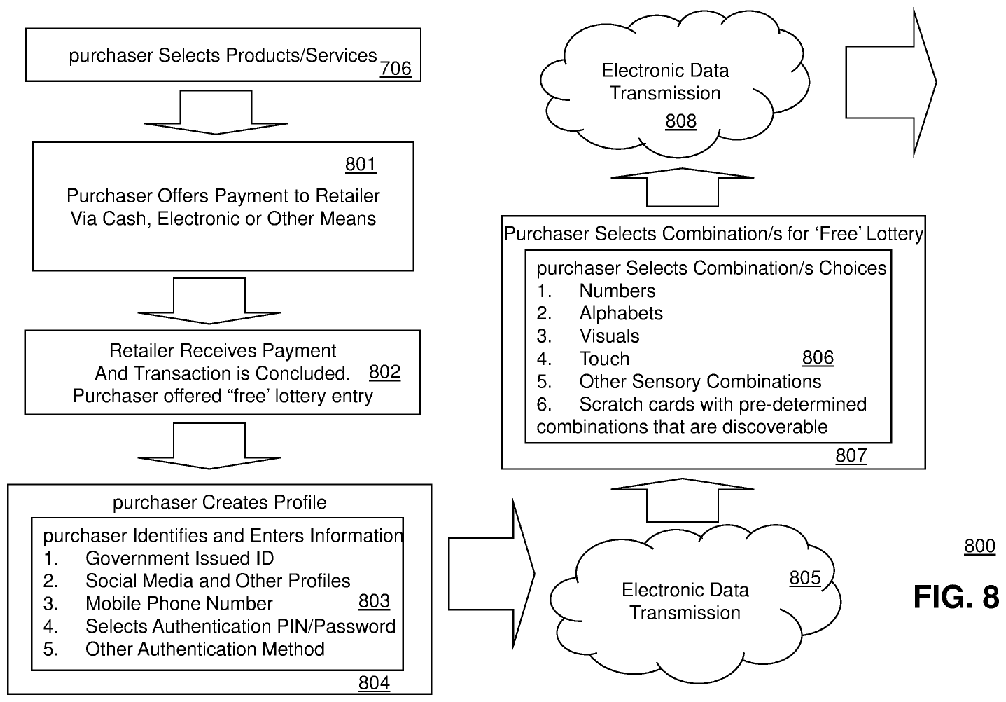

In FIG. 8, the purchaser then chooses to purchase the retailer's goods and/or services and proceeds to pay for it at 706, at which point, the retailer provides payment options that the purchaser can accept. The payment options 801 can include, for example, mobile number, account, cash, credit cards, debit cards, payment service provider, mobile wallet, mobile banking, stored value card, bank transfer, third party wire transfer, money order, traveler's checks, loyalty scheme value, reward points, foreign exchange, cryptocurrency or other such means and methods, and the like. The retailer then acknowledges receipt of payment 802 in lieu of the goods and services that has been sold to the purchaser and the transaction concludes, and then offers the purchaser the “option” to enter a “free” lottery by creating their profile in the lottery operator's database, and selecting a combination of elements with a pre-defined universe, as previously described. The profile 804 of the purchaser can include any suitable number of data points 803, for example, including name, license, passport, email, mobile phone number, picture, fingerprints, national identity number or card scan, age, sub-profiles of family members and their information, selection of authentication PIN, Password, Passcode, other such validation data point or points, and the like, and the data is stored in the purchaser's unique profile 804 on the lottery operator's platform, including the purchased goods or services that is then stored and updated in the database 805. The purchaser then selects their lottery combination(s) 807 which can be a limited selection from a universe of numbers, alphabets, visual, smell, touch or other sensory elements 806. The purchaser can be offered multiple chances or entries in lieu of their purchase and/or transaction. Accordingly to illustrate the process of entering the optional “free” lottery, the purchaser (e.g., in the instance of one of several lottery and gaming methods that exist and may in the future be invented) selects 6 out of 49 numbers on a draw sheet or on their mobile device (e.g., such as an electronic tablet or phone) or on an interactive television or via some other such method that allows for a combination of audio, visual, smell, touch or other sensory or some other choices to be made that would eventually need to match a draw that would take place upon a set time and date. The goods and/or service purchased, as well as the lottery entry or entries selection combinations are then recorded in the purchaser's profile in the lottery operator's database 808.

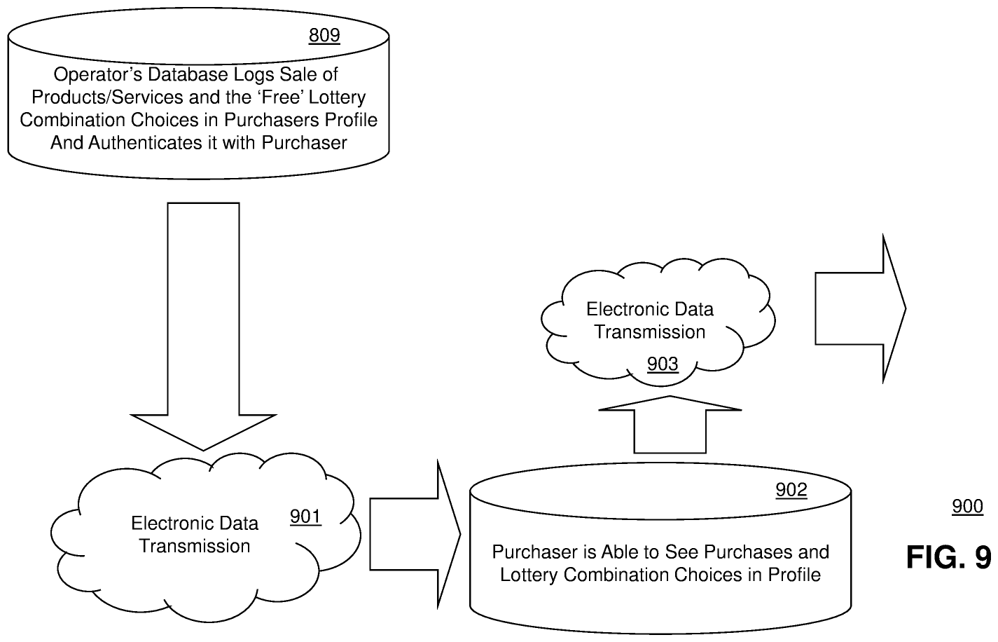

In FIG. 9, the lottery operator's database logs the purchase and lottery combination in the purchaser's profile and sends them an authentication request to confirm that the information is correct, and records the confirmation 809 in the database 901. The purchaser then is able to access their profile and records 902 within it at any given time using their login credentials, and by securely authenticating themselves against the authentication method and validation points that they chose by accessing the database 903 of the lottery operator.

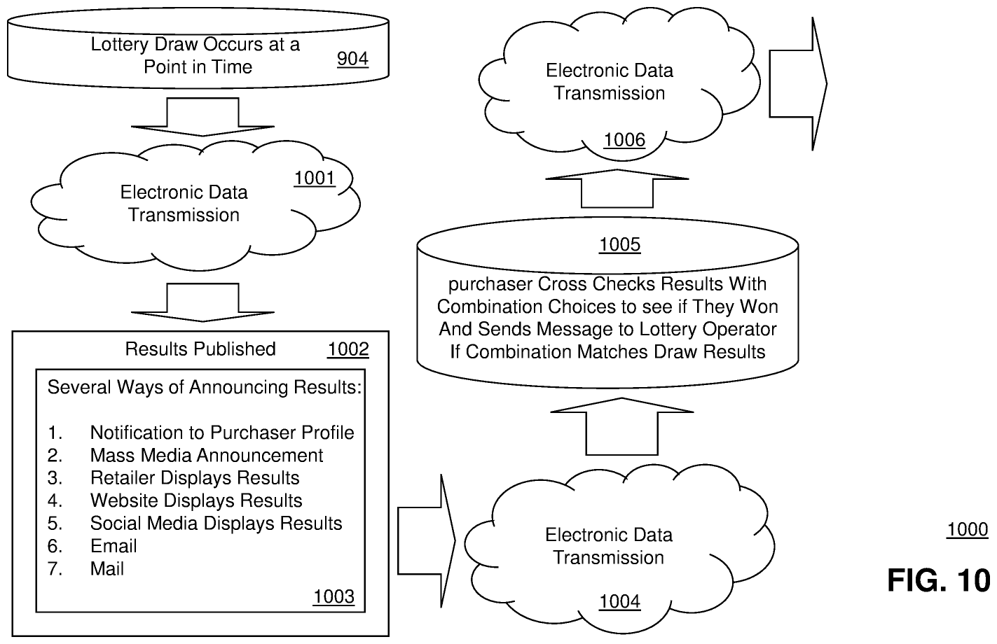

In FIG. 10, The lottery operator conducts a live draw 904 that is broadcasted at 1001 via television, radio, internet streaming, and the like, for example, while presented to an audience in a studio or other indoor or outdoor venue setting, and for example which has reputed auditors present to ensure trust, and transparency. The draw establishes the winning lottery combination 1002, and the results are then published via broadcast mediums, and notifications are sent to purchasers via a host of channels that they have selected in their profile to be notified about the lottery draw's winning combination 1003, such as notification via the purchaser's profile in the lottery operator's database, social media, text messages or calls to their phones, email, mail or other suitable means of communication. The purchaser then manually or automatically checks their own lottery selection combination entry or entries against the winning numbers or can simply access their profile in the lottery operator's database 1004, and for example, click a button to check if their lottery selection combination matched the winning combination in whole or part, and whether they won the jackpot and/or other prizes 1005, and which is processed electronically at 1006 with a response back to the purchaser.

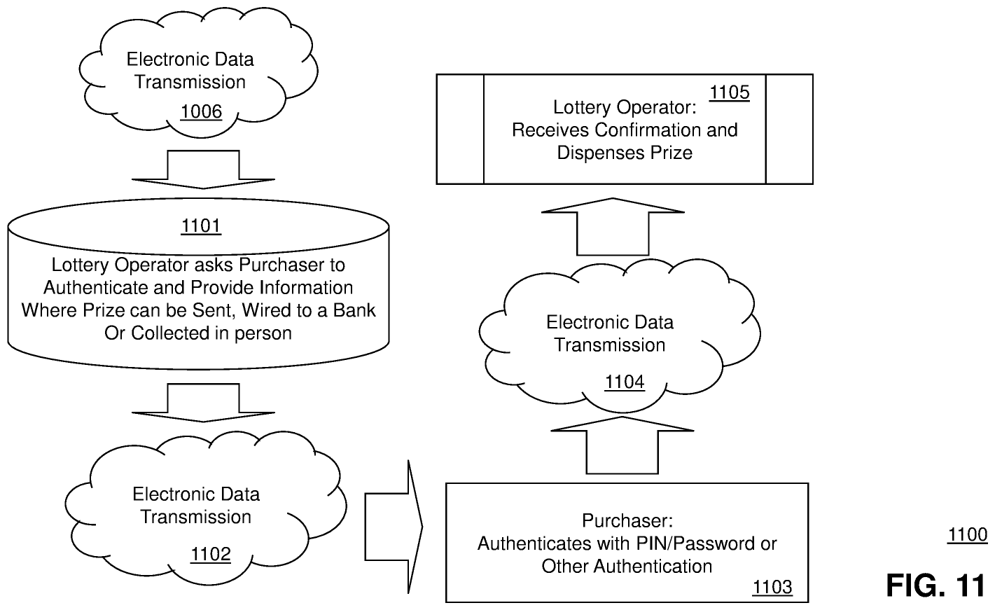

In FIG. 11, the purchaser is informed electronically at 1006, whether or not their lottery selection combination wholly or partly matched the winning lottery combination. In the case where in whole or part the purchaser's selection did match the winning lottery combination, the purchaser authenticates themselves at 1101 against a request from the lottery operator to redeem prize(s) at 1102, and once the authentication is validated at 1103, then either the purchaser or the lottery operator can initiate communication to discuss modalities 1104 of redeeming the prize(s) delivery mechanism 1105, and the purchaser either receives the prize or collects it, completing the system processing.

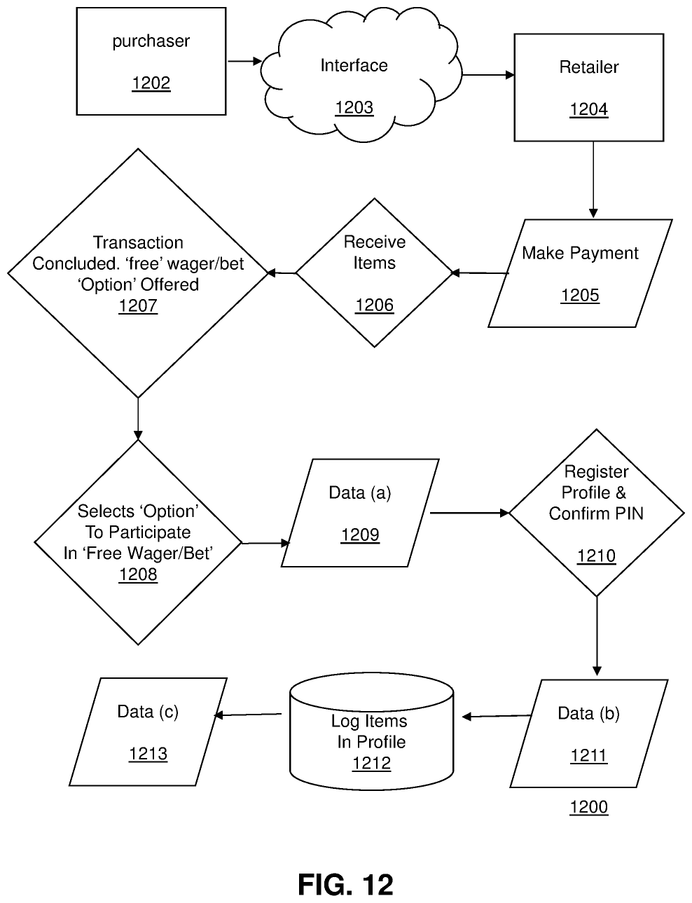

FIGS. 12-14 illustrate an exemplary general process flow, as applied to betting or gaming, according to an exemplary embodiment. In FIG. 12, the process begins with purchaser 1202 who interfaces or interacts 1203 with a retailer's 1204 store, e-store (e.g., web site), telephone sales persons, interactive voice response (IVR) system, vendor, restaurant, other such interface, and the like, and including personal face-to-face, purchase or consumption of goods and/or services. Purchaser 1202 selects or purchases or consumes goods and/or services from retailer 1204 and proceeds to make payment 1205 for it at check-out where he has several payment options to choose from cash, card, cryptocurrency, foreign currency or any other tender type. Once payment is made by the purchaser to the retailer then the transaction is concluded and the purchaser receives the goods and/or service that they purchased 1206. The retailer then offers the purchaser the option to enter the “free” wager or bet 1207. The purchaser selects the option to enter the “free” wager or bet 1208 and the merchant selects the option indicating the purchaser's desire to opt-in for the wager or bet 1209 and the data is recorded in the merchant's system and asks the purchaser to create their digital profile registration 1210. The purchaser enters all details that may be required by the wager or betting operator including and not limited to name, license, passport, email, mobile phone number, picture, fingerprints, national identity number or card scan, age, sub-profiles of family members and their information, selection of authentication PIN, Password, Passcode, other such validation data point or points 1211 and the data is stored in the purchaser's unique profile on the wager or betting operator's platform including the purchased goods or services 1212 that is then stored and updated in the database 1213.

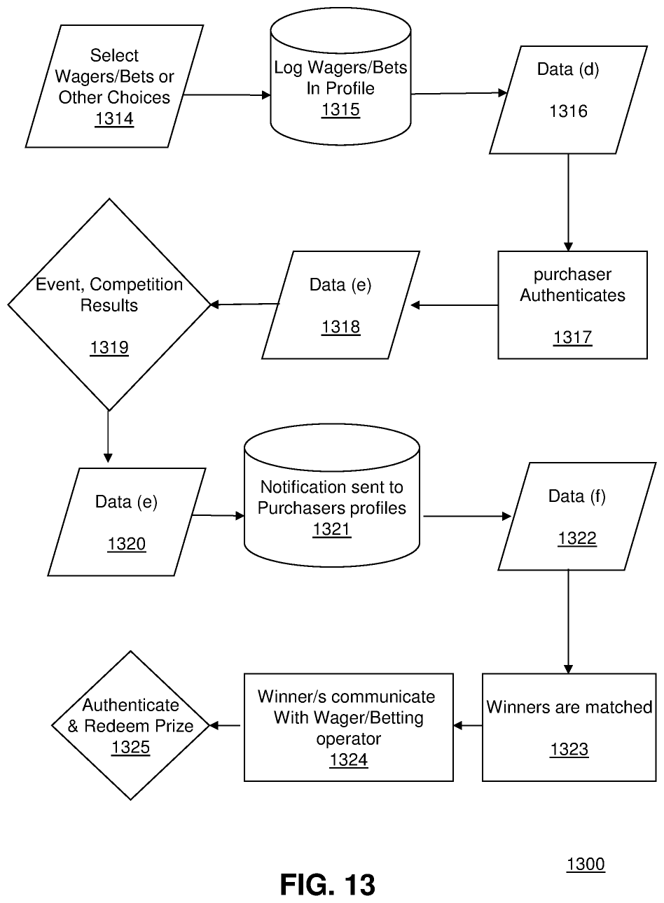

In FIG. 13, the purchaser selects the wager or betting combination(s) and confirms their entry 1314 into the wager or betting for the upcoming event, competition, game, transaction which is then logged into their profile 1315 and the database is updated 1316. The purchaser is then asked to authenticate themselves with the authentication factor(s) that they had selected thereby creating a digital signature certifying ownership of the goods and/or services as well as the wager or betting selection combination entry 1317 and the result of the verification, authentication is encapsulated as a digital signature that is then updated in the database 1318. The wager or betting operator then posts the results of the event, competition, game, or transaction across multi-media and/or may reference other media carrying the results to ensure trust and transparency 1319. The winning result(s) and/or combination(s) are then recorded in the wager or betting operator's database 1320 and notifications are sent 1321 to purchaser's via their profile using various channels such as email, text messaging, social media, in-app notification, call to their telephone number, etc., and all this is logged in the wager or betting operators database. If there are any matches from the wager or bets with the event, competition, game, transaction results, winner(s) are matched 1323 and the wager or betting operator may decide to notify the winner via their contact information or may just let the winner discover for themselves if they have won by referencing their entry against the winning results by either manual matching or clicking on a button in their profile that allows for automated matching to see if they won or matched any of the wagers or bets with the winning results. The winner(s) 1324 identify themselves and communicate with the wager or betting operator to redeem their prizes after authenticating themselves 1325.

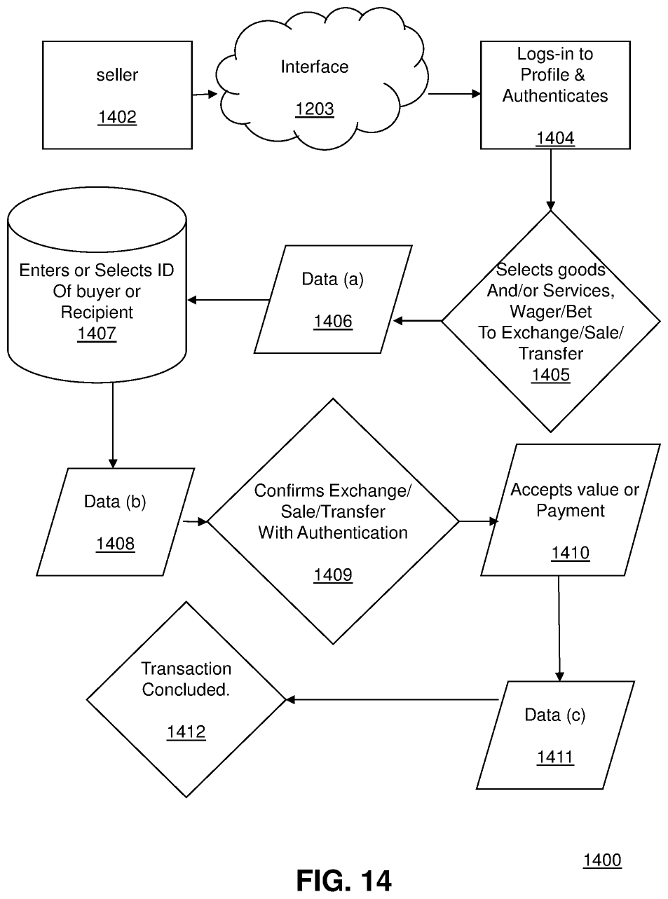

In FIG. 14, the trading process of the goods and/or services and/or the wager or bet selection combination entry is illustrated. The seller 1402 uses an interface that could be through a web browser, app or in-person at an authorized retailer 1203 to login to their profile 1404 after securely authenticating themselves. The seller then selects goods and/or services and/or wager or bet entry that they wish to trade or sell 1405. The database records the selection 1406 and generates a transaction token with all the details referencing the selection of the items being transferred or sold and the buyer's information 1407 and the database is updated with the transaction information 1408. The seller and the buyer both authenticate the transaction and the entry is recorded in the database with their own authenticated digital signatures 1409 after the agreed upon value or payment has been exchanged 1410 and the databases updated 1411 which then provides receipts to both profiles and the transaction is concluded 1412

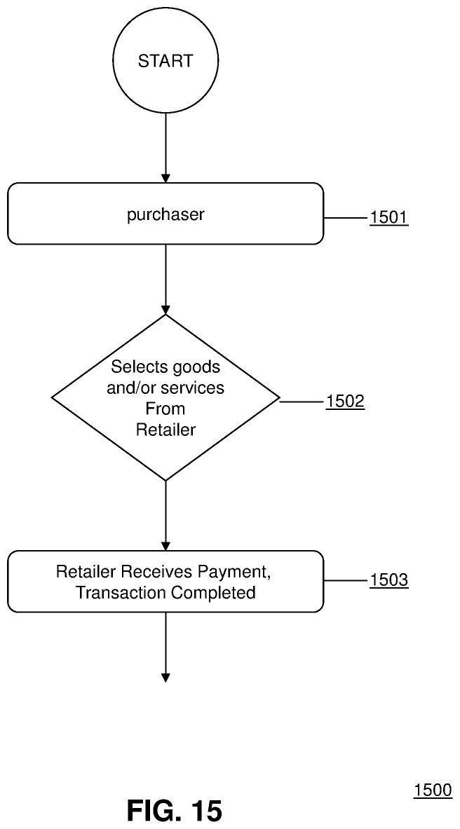

FIGS. 15-17 illustrate an exemplary flow chart corresponding to the exemplary process of FIGS. 12-14. In FIG. 15, the purchaser 1501 selects goods and/or services, for example, from a retailer, vendor or merchant at step 1502 at a store, on the internet, vendor, vending machine, restaurant, mobile browser, through a telephone sales person or sales IVR, and/or other such sales avenues or interfaces as the purchaser may be presented with by the retailer. Retailer at step 1503 receives payment via any number of payment options such as but not limited to cash, credit card, debit card, mobile wallet, mobile phone number or account, bank transfer, stored value cards, foreign currency, cryptocurrency and others. Upon receiving the payment, value is exchanged and the transaction is completed.

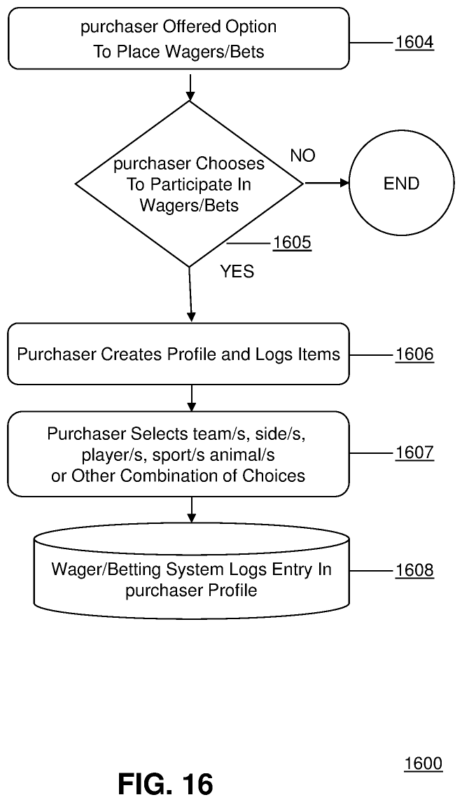

In FIG. 16, the retailer presents the purchaser an option to enter a “free” wager or bet at step 1604 by selecting their own team(s), side(s), player(s), sports animal(s), etc., for their entry such as a football team, football player, or their favorite horse or greyhound on a paper card or an interactive screen such as that of a table, phone or some such device including and not limited to the cash register of the merchant. The incentive for the purchaser is that the wager or bet selection is “free” and that they hope to win the grand prize or some of the other prizes depending on whether their wager or bet selection combination matches the event, competition, game or transaction result. If the purchaser doesn't opt to participate in the wager or bet the transaction and process end here. If the purchaser opts to enter the wagers or bets selection combination 1605, they are required to create their user profile 1606 with any number of data points including but not limited to name, license, passport, email, mobile phone number, picture, fingerprints, national identity number or card scan, age, sub-profiles of family members and their information, selection of authentication PIN, Password, Passcode, other such validation data point or points and the data is stored in the purchaser's unique profile on the wager or betting operator's platform including the purchased goods or services that is then stored and updated in the database. The purchaser then selects their wager or bet combination 1607 and an entry is created and stored in their profile 1608.

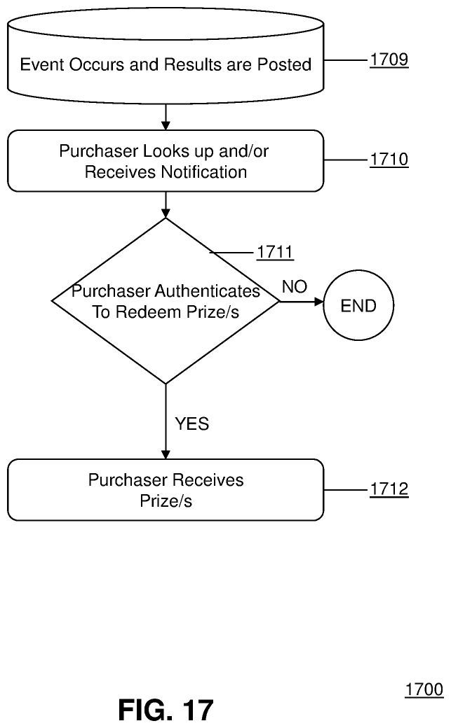

In FIG. 17, the wager or betting operator publishes the event, game, competition, transaction results or makes available references and/or links to other media or publishers who cover the event results to allow anyone including the purchasers to view the results 1709. The winning result(s) combination(s) are then published and the purchasers are sent notifications 1710 so that they can tally their wagers or bets selection combination against the winning results 1711. The purchasers whose wagers or bets selection(s) or combination(s) do not match the winning results may or may not be rewarded with anything. The purchasers whose wagers or bets combination(s) match the results, they may then proceed to authenticate themselves to redeem their prize(s) 1712. The prizes may be collected or delivered, in many forms including but not limited to cash, check, money transfer, credit or debit card, cryptocurrency, foreign currency or some such other form of tender or physical goods or services.

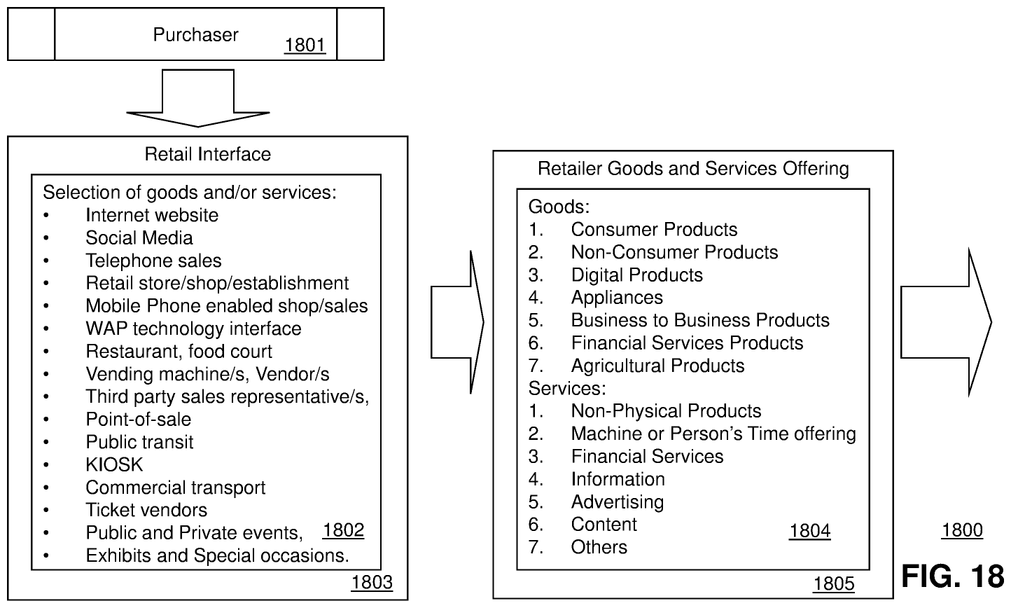

FIGS. 18-22 illustrate the operation of an exemplary system corresponding to the exemplary process and flow chart of FIGS. 12-17. In FIG. 18, there is illustrated the authenticated sharia compliant wager or betting 1800, according to an exemplary embodiment. The system, begins with the purchaser 1801 who interacts with a retailer's interface 1803 whereby selecting goods and/or services presented by the retailer to the purchaser to select and/or consume 1802 through a variety of ways including, for example, retailer's Internet website (e-commerce or e-retail, shop or sales front), telephone sales, retail or catalogue shop or team (e.g., call center, catalogue sales), mobile phone enabled shop or sales presence using, for example, Wireless Application Protocol (WAP) technologies, and the like, interfacing with, for example, the internet, physical store front or other such establishment in the form of retail store or shop, including, for example, restaurants, vending machines, vendors, third party representatives, point-of-sale including, for example, services such as payment mechanisms configured for public transport such as taxis, buses, subways or metro or underground and over ground transport or trains or monorails, commercial aircraft or airlines or buses and other transport, toll-booths, ticket vendors or stands or internet sites for public and private events, exhibits and special occasions, interactive televisions or other such screens in homes or other private or public places, smartphones or feature phones, through apps on the smartphone or computers, and the like.

The retailer offers 1805 goods and/or services that may include physical goods such as merchandize of a certain value, limited edition collector's cards, antiques, financial services products, agricultural products, appliances, digital goods, non-consumer products such as industrial equipment. The retailer may also offer services such as machine time, person's time, information, advertising, advice, content and other non-tangible services.

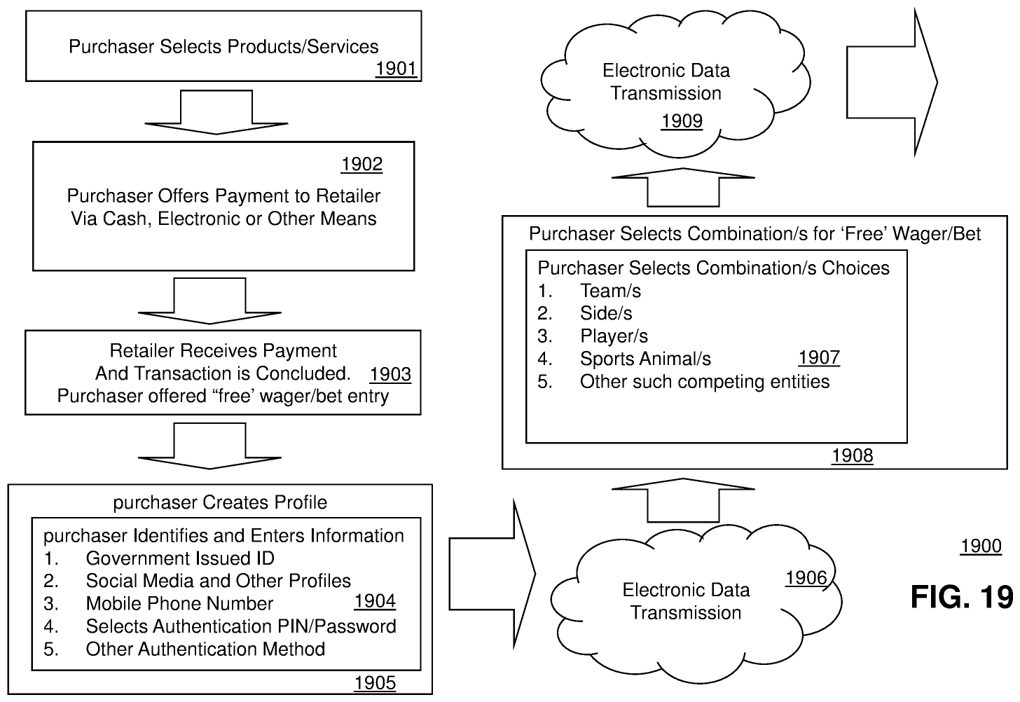

In FIG. 19, the purchaser then chooses to purchase the retailer's goods and/or services and proceeds to pay for it 1901 at which point, the retailer provides payment options that they accept. The payment options include 1902, for example, mobile number or account, cash, credit cards, debit cards, payment service provider, mobile wallet, mobile banking, stored value card, bank transfer, third party wire transfer, money order, travelers' checks, loyalty scheme value, reward points, foreign exchange, cryptocurrency or other such means and methods. The retailer then acknowledges receipt of payment 1903 in lieu of the goods and services that has been sold to the purchaser and the transaction concludes and then offers the purchaser the option to enter “free” wagers or bets by creating their profile in the wager or betting operator's database and selecting a combination of events, games, competition, transaction elements with a pre-defined universe of teams, players, participants, sports animals, etc. The profile of the purchaser may include any number of data points 1904 including but not limited to name, license, passport, email, mobile phone number, picture, fingerprints, national identity number or card scan, age, sub-profiles of family members and their information, selection of authentication PIN, Password, Passcode, other such validation data point or points 1905 and the data is stored in the purchaser's unique profile on the wager or betting operator's platform including the purchased goods or services that is then stored and updated in the database 1906. The purchaser then selects their wagers or bets combination(s) 1908 which could be a selection from a universe of teams, players, participants, sports animals, etc., or other elements 1907. The purchaser could be offered multiple wagers or bets or entries in lieu of their purchase and/or transaction. Accordingly to illustrate the process of entering the optional “free” wagers or bets, the purchaser (in the instance of one of several wager or betting and gaming methods that exist and may in the future be invented) selects their team(s), player(s), side(s), sports animal(s), and/or other such competing entities on a draw sheet or on their mobile device (such as an electronic tablet or phone) or on an interactive television or via some other such method that allows for a combination of wagers or bets or some other selections to be made that would eventually need to match the event, competition, game, transaction result that would take place upon a set time and date. The goods and/or service purchased as well as the wager or bet selection or entries selection combinations are then recorded in the purchaser's profile in the wager or betting operator's database 1909.

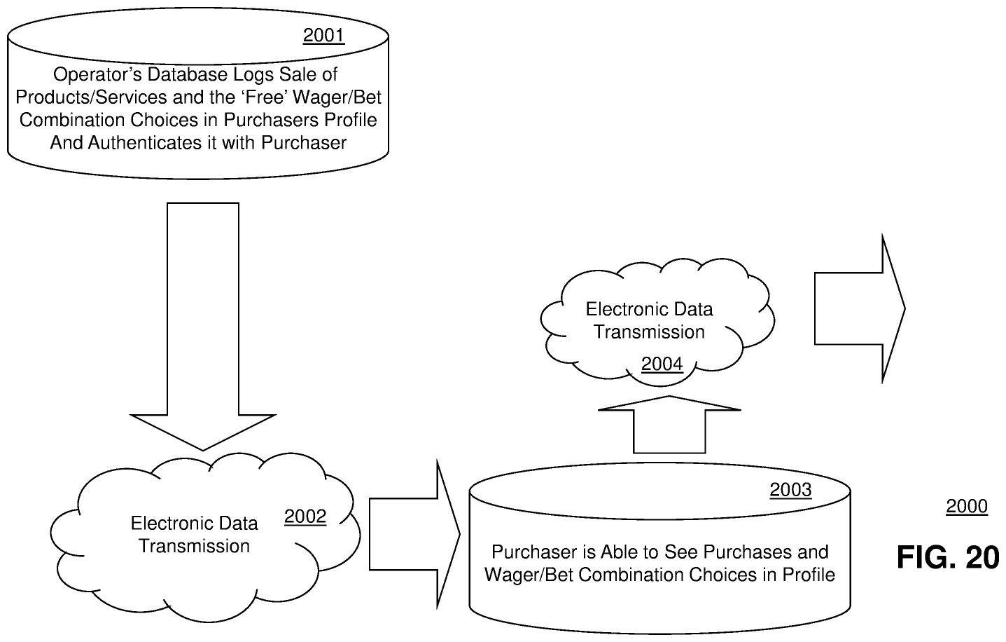

In FIG. 20, the wager or betting operator's database logs the purchase and wager or bet selection in the purchaser's profile and sends them an authentication request to confirm that the information is correct and records the confirmation 2001 in the database 2002. The purchaser is able to access their profile and records 2003 within it at any given time using their login credentials and securely authenticating themselves against the authentication method and validation points that they chose by accessing the database of the lottery operator 2004.

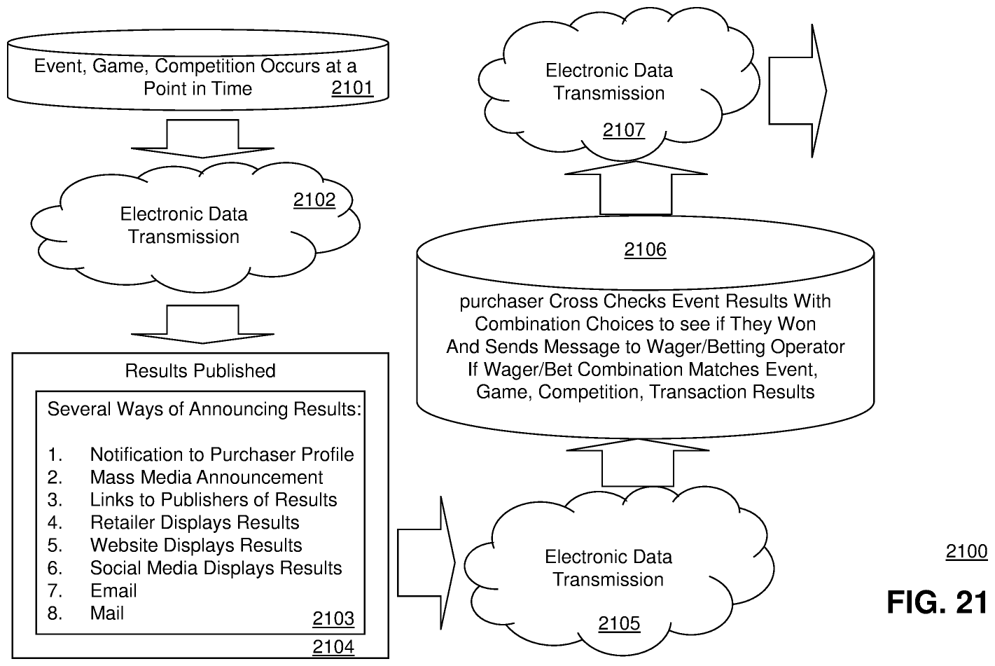

In FIG. 21, The wager or betting operator publishes the events, game, competition, transaction results and/or provides reference and/or links to such publishers of results 2101 that is broadcasted via television, radio, internet streaming while presented to an audience in a studio or other indoor or outdoor venue setting 2102 and may have reputed auditors present to ensure trust and transparency. The results of the event(s), competition(s), game(s) and transaction(s) establishes the winners 2103 and the results are then published via broadcast mediums and notifications are sent to purchasers via a host of channels that they have selected in their profile to be notified about the lottery draw's winning combination 2104 such as notification via the purchaser's profile in the wager or betting operator's database, social media, text messages or calls to their phones, email, mail or other such means of communication 2105. The purchaser then manually checks their own wager or bet selection combination entry or entries against the winning results or may simply access their profile in the wager or betting operator's database and click a button to check if their wager or bet selection combination matched the winning results and/or combination and whether they won the grand prize and/or other prizes 2106 and this processed electronically 2107 with a response back to the purchaser.

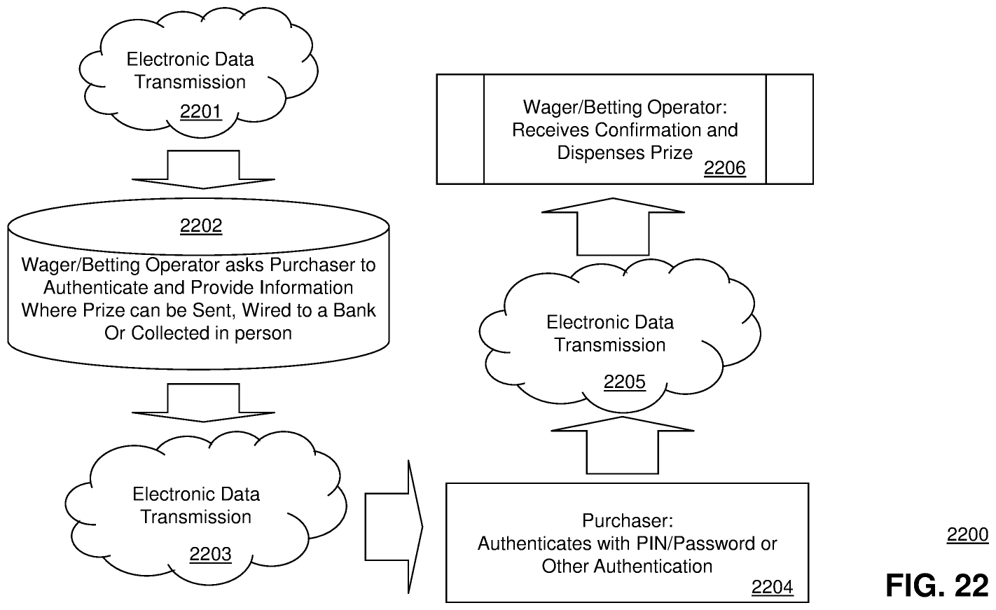

In FIG. 22, the purchaser is informed electronically whether their wager or bet selection combination matched the winning results combination 2201. In the case where the purchaser's selection did match the winning results 2202 then the purchaser needs to authenticate themselves against a request from the wager or betting operator to redeem prize(s) 2203 and once the authentication is validated 2204, then either the purchaser or the wager or betting operator can initiate communication to discuss modalities 2205 of redeeming the prize(s) delivery mechanism 2206 and the purchaser either receives the prize or collects it.

Thus, the present embodiments include a system, method and computer program product that not only offers a lottery or betting or gaming scheme that negates the “gambling” notion of a lottery, bet or game, and is in accordance to and respects the values of Islam and Sharia law or other religions and/or beliefs that shun gambling, but additionally also offers a secure way of authenticating a transaction and purchase of goods and/or services, and generates a record of provenance that then can itself increase in value in a secondary market. Such authenticated exchange of value with a record of provenance then allows the purchaser an “option” to also play a lottery, bet or game in the “hope” that they may win the jackpot and/or other prizes that could positively benefit them and/or even change their livelihood. The record of the lottery bet or gaming numbers, team(s), side(s), participant(s), candidate(s), player(s), sports animal(s) selected are also stored securely in a database associated with the purchaser's profile or identity and access to which is controlled by the purchaser and authenticated against by the purchaser at the time of redemption against the master database or ledger maintained by the operator or sponsor of the lottery, betting or gaming and/or scheme, and with the authentication system the purchaser can also sell their entry to a buyer because of the ability to authenticate and record provenance.

The computer implemented system can be configured for offering the “option” to a purchaser of goods and/or services to participate in a “free” Sharia compliant lottery, betting or gaming scheme and choose a limited selection combination of elements for a broader universe of elements in the hope that their combination will match the lottery, bet or game results or draw that will take place at a designated time and date by the lottery, betting or gaming operator. A retailer can be configured for selling goods and/or services to a purchaser in exchange for monetary or in-kind value exchange to conclude a transaction. The retailer, upon concluding the sale to the purchaser, offers them the “option” of entering a “free” lottery, bet or game. The retailer upon receiving a positive response from the purchaser to enter the lottery bet or game, accesses the lottery, betting or gaming operator's platform database to create the purchaser's profile. The purchaser completes their profile and sets authentication methods and validates against it. The retailer scans or enters the ID of the goods and/or services that the purchaser paid for and records it in the purchaser's profile. The retailer then asks the purchaser to select a limited combination of elements from a broader universe of elements as their lottery, bet or game entry such as team(s), side(s), participant(s), candidate(s), player(s), sports animal(s) which is then stored in their profile in the lottery, betting or gaming operator's database. The retailer may offer the purchaser multiple “free” lottery, bet or game entries per purchase or transaction. The retailer may offer the purchaser other free lottery bet or game options, such as scratch cards with pre-determined combinations that are discoverable instantly. The lottery, betting or gaming operator conducts a live draw or publishes and/or references other publishers of bet, game or event results at pre-determined and designated time and date securely and transparently and reports the winning combination that purchasers can manually or electronically match their own lottery, bet or game selection combinations against. If the purchaser's various lottery, bet or game entries selection combinations matches in part or wholly the lottery, bet or game results or draw's winning combination, then the purchaser is eligible to claim prizes after they authenticate themselves. The purchaser's recorded purchase of the goods and/or service as well as their selection combination lottery, bet or game entries is tradeable and/or transferable with profiles of other purchasers on the lottery operator's platform database and/or third party user profiles on other third party platform databases. The authentication by sellers and buyers to trade their lottery, bet or game entries can additionally apply to traditional lotteries, betting or gaming schemes to address issues related to winner's identity disputes. The authentication of the user provides current lottery, betting or gaming operators, states and other actors the ability to sell tickets online while preserving the integrity of the lottery, bet or game entry and provenance which in turn creates additional cost-efficiencies associated with direct sales which bypasses merchant commissions and the need for costly equipment and operations, including payment collections and costs associated with it. The purchaser's goods and/or services and/or lottery, bet or game entry price may or may not have value or may be set by the purchaser, lottery, betting or gaming operator or market forces.

The computer implemented method corresponding and system are configured for operating and processing a lottery, bet or game selection and offering the “option” to a purchaser of goods and/or services to participate and enter a “free” lottery, bet or game in the anticipation of winning a grand prize or jackpot and/or other prizes, which in the general lotteries offered in their present traditional form require people to “pay to play” in order to participate, select their combination and enter the lottery, bet or game. The traditional “pay to play” lotteries, betting and gaming schemes deprives many Muslims who hold their religious beliefs in high esteem, from participating because of the notion of gambling associated with “purchasing” a lottery, bet or game ticket with only a “chance” to win at the expense of others who lose as well as lose their own money if they don't win.

The system and method allows for both the seller and the buyer employing authentication in order to securely conclude the transaction and eliminate fraud. Authentication is also advantageous upon the participant winning a prize for the lottery, bet or game they entered in order to make sure that the recipient of the prize is the original participant that had opted to participate in the “free” lottery, bet or game. This is novel from the current approach to selling a lottery, betting or gaming ticket whereby the participant in a lottery, bet or game may lose their ticket and someone else may claim the prize because there is no way to authenticate the original participant.

The above-described devices and subsystems of the exemplary embodiments can include, for example, any suitable servers hosted in the cloud (SAAS) or at data centers locally, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 5G LTE communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like (e.g. circuitry), programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of the appended claims.

1. A computer implemented system for validating a transaction and recording the transaction to a blockchain comprising:
circuitry configured to:
implement a first transaction between a user and an entity;
upon concluding the first transaction, provide the user a possibility of entering into a complimentary second transaction via a graphical user interface;
upon receiving a positive response from the user in response to the provision:
implement the complimentary second transaction, and
access a transaction system database to create a profile of the user;
permit the user to complete the profile via the graphical user interface and set at least one authentication basis;
validate the profile using the at least one authentication basis; and
record the first transaction and the complimentary second transaction in the blockchain in response to the validation.

2. A computer implemented system for validating a transaction comprising:
circuitry configured to:
implement a first transaction with a purchaser;
upon concluding the first transaction, offer the purchaser an option of entering a free second transaction;
upon receiving a positive response from the purchaser in response to the offer:
enter the free second transaction, and
access a transaction system database to create a profile of the purchaser;
allow the purchaser to complete the profile and set at least one authentication method;
validate the profile using the at least one authentication method; and
record the first transaction and the free second transaction in a trusted and/or immutable ledger.

3. The computer implemented system of claim 2, wherein the trusted and/or immutable ledger includes a blockchain.

4. A computer implemented system comprising:
a retailer system configured to:
sell goods and/or services to a purchaser in exchange for monetary or in-kind value exchange to conclude a transaction;
upon concluding the transaction, offer the purchaser an option of entering a free lottery, bet, or game;
upon receiving a positive response from the purchaser in response to the offer:
enter the free lottery, bet, or game, and
access a lottery, betting, or game operator system database to create a profile of the purchaser;
allow the purchaser to complete the profile and set at least one authentication method;
validate the profile using the at least one authentication method; and
record the transaction and the free lottery, bet, or game in a trusted and/or immutable ledger.

5. The computer implemented system of claim 4, wherein the retailer system is further configured to:
scan or enter identifications of the goods and/or services sold to the purchaser, and
record the identifications in the profile of the purchaser.

6. The computer implemented system of claim 4, wherein the retailer system is further configured to:
allow the purchaser to select a limited combination of elements from a broader group of elements as a lottery entry, bet, or game selection, and
store the limited combination of elements in the profile in the game operator system database.

7. The computer implemented system of claim 4, wherein the retailer system is further configured to:
offer the purchaser one or more free lottery, bet, or game entries per purchase or transaction by the purchaser, the one or more free lottery, bet, or game entries including scratch cards with pre-determined combinations that are discoverable instantly.

8. The computer implemented system of claim 4, further comprising:
a lottery, betting, or game operator system configured to:
conduct a live draw or publish or reference other publishers of lottery, betting, or game results at a pre-determined and designated time and date securely and transparently, and
report the results such that the purchaser can manually or electronically match against the free lottery, bet, or game entry.

9. The computer implemented system of claim 4, wherein the lottery, betting, or game operator system is further configured to use a profile of a buyer, a profile of a seller, the at least one authentication method, a provenance of the goods and/or services, and/or the lottery, bet, or game entry to facilitate a trade of the goods and/or services and/or the lottery, bet, or game entry.

10. The computer implemented system of claim 9, wherein the retailer system is further configured to:
encapsulate the validation as a digital signature, and
update the lottery, betting, or game operator system database with the digital signature.

11. The computer implemented system of claim 10, wherein the lottery, betting, or game operator system includes the lottery, betting, or game operator system database.

12. The computer implemented system of claim 11, wherein
the lottery, betting, or game operator system database is further configured to generate a token including details of the goods and/or services, and/or the lottery, bet, or game entry of the trade and information of the buyer,
the seller and the buyer authenticate the trade, and
the lottery, betting, or game operator system database is updated with a digital signature of the seller and a digital signature of the buyer.

13. The computer implemented system of claim 4, wherein a record of the transaction and the free lottery, bet, or game is recorded in a trusted and/or immutable ledger.

14. A computer implemented method comprising:
selling goods and/or services to a purchaser in exchange for monetary or in-kind value exchange to conclude a transaction;
upon concluding the transaction, offering the purchaser an option of entering a free lottery, bet, or game;
upon receiving a positive response from the purchaser in response to the offer:
entering the free lottery, bet, or game, and
accessing a lottery, betting, or game operator system database to create a profile of the purchaser;
allowing the purchaser to complete the profile and set at least one authentication method; and
validating the profile using the at least one authentication method.

15. The computer implemented method of claim 14, further comprising:
scanning or entering identifications of the goods and/or services sold to the purchaser, and
recording the identifications in the profile of the purchaser.

16. The computer implemented method of claim 14, further comprising:
allowing the purchaser to select a limited combination of elements from a broader group of elements as a lottery entry, bet, or game selection, and
storing the limited combination of elements in the profile in the game operator system database.

17. The computer implemented method of claim 14, further comprising offering the purchaser one or more free lottery, bet, or game entries per purchase or transaction by the purchaser, the one or more free lottery, bet, or game entries including scratch cards with pre-determined combinations that are discoverable instantly.

18. The computer implemented method of claim 14, further comprising:
conducting a live draw or publish or reference other publishers of lottery, betting, or game results at a pre-determined and designated time and date securely and transparently, and
reporting the results such that the purchaser can manually or electronically match against the free lottery, bet, or game entry.

19. The computer implemented method of claim 14, further comprising using a profile of a buyer, a profile of a seller, the at least one authentication method, a provenance of the goods and/or services, and/or the lottery, bet, or game entry to facilitate a trade of the goods and/or services and/or the lottery, bet, or game entry.

20. The computer implemented method of claim 19, further comprising:
encapsulating the validation as a digital signature, and
updating the lottery, betting, or game operator system database with the digital signature

21. The computer implemented method of claim 20, further comprising:
generating a token including details of the goods and/or services, and/or the lottery, bet, or game entry of the trade and information of the buyer,
authenticating the trade, and
updating the lottery, betting, or game operator system database with a digital signature of the seller and a digital signature of the buyer.

22. A computer program product including one or more computer readable instructions embedded on a non-transitory computer readable medium and configured to cause one or more computer processors to perform the method of claim 14.
